(19) United States
(12) Patent Application Publication
(10) Pub. No.: US 2009/0089723 A1
(43) Pub. Date: Apr. 2, 2009

(54) Circuit design using a spreadsheet

(76) Inventors: Thomas Fletcher, Porland, OR (US); Matthew Morrise, Portland, OR (US)

Correspondence Address: KED & ASSOCIATES, LLP;INTEL CORPORATION, P.O. BOX 221200, CHANTILLY, VA, 20153-1200, US

(21) Appl. No.: 11/905,416

(22) Filed: Sep. 28, 2007

(51) Int. Cl. G06F 17/50

(52) U.S. Cl. 716/4; 716/18

(57) ABSTRACT

A circuit design method is provided that includes creating a plurality of macros each for one of a plurality of logic gates, storing the created macros, and creating a circuit design using a spreadsheet program, the circuit design being represented by the plurality of macros.

### BACKGROUND

1. Field

Embodiments of the present invention may relate to circuit design and/or datapath design.

2. Background

Digital products are being designed and developed with more and more functions. Digital circuits may include digital functional elements such as logic gates etc. Digital circuits are becoming complex for designing and testing. Digital circuits may be designed by drawing schematics, may be tested under simulated test conditions for various combinations of input conditions, and may be refined for desired output parameters. However, the drawing of schematics is labor intensive and time consuming. The incorporation of any changes to the schematics is also very labor intensive and time consuming. The logical debugging of schematics may also be very difficult.

### BRIEF DESCRIPTION OF THE DRAWINGS

Embodiments may be described in detail with reference to the following drawings in which like reference numerals refer to like elements and wherein:

FIG. 1 is a flowchart of a method according to an example embodiment of the present invention;

FIG. 2 shows a portion of a spreadsheet displaying a circuit design according to an example embodiment of the present invention;

FIG. 3 shows a portion of a spreadsheet during testing of a circuit design according to an example embodiment of the present invention; and

FIG. 4 is a block diagram of a computer system for performing circuit design according to an example embodiment of the present invention.

### DETAILED DESCRIPTION

In the following description, like reference numerals may be used to designate identical, corresponding or similar components in different drawings. Where specific details are set forth in order to describe example embodiments, it should be apparent to one skilled in the art that embodiments may be practiced without these details.

Embodiments of the present invention may provide an integrated interactive system and method for circuit (or datapath) design using a spreadsheet that supports macro programming, such as the Microsoft Excel™ spreadsheet program, for example. Other spreadsheet programs that support macro programming may also be used. The terms spreadsheet and/or spreadsheet program may hereafter be used interchangeably.

Embodiments of the present invention may allow a user to generate netlists, generate schematics from the netlists, and perform testing and debugging of a desired circuit using the spreadsheet program and/or associated programs. Embodiments of the present invention may also use the spreadsheet program (and/or associated program) to verify logic of a circuit design, test the logic, produce a netlist, provide layout directions, generate schematics, generate color coded block diagrams, generate prefix graphs and/or calculate average activity factors for power estimation.

A spreadsheet is an example of a software application that implements a table, and that can perform various numerical and other operations on information that a user enters into the table. A spreadsheet may have rows and columns of individual cells that can each contain specific information. The user may define formulas in some of the cells which are a function of the information residing in other cells.

A spreadsheet may be used to represent a circuit design (or datapath design). For example, a spreadsheet may represent an adder circuit by specifying inputs along at least two rows of the spreadsheet and entering specific logic formulas that correspond to specific cells in the spreadsheet. Other circuits and/or logic formulas may also be provided.

Each cell in the spreadsheet may represent a gate in a circuit (e.g. an inverter, a NAND gate, etc.). Each cell may be associated with a specific macro that implements a function of the logic gate associated with the cell. For example, inputs to the gate may be associated with other cells in the spreadsheet. The cells may contain logic states (i.e., a “1” or a “0”) or may themselves represent other gates. Accordingly, an entire circuit (or circuit design) may be represented using the spreadsheet and functionality of the circuit may be simulated when the macros representing the gates are run using the spreadsheet. Macros associated with the spreadsheet may algorithmically calculate the expected result for the circuit based on inputs to the spreadsheet. An expected result may then be compared to the simulated result. Stated differently, a functionality test of the circuit may be performed by inputting (or injecting) random or predetermined inputs into the circuit via the spreadsheet.

Embodiments of the present invention may allow a user to create a logic gate function library for the spreadsheet using a spreadsheet module, such as a Visual Basic (hereafter VB) module. The logic gate function library may relate to a plurality of logic gates and a plurality of corresponding logical functions. More specifically, a user may create the library by entering logic gate functions for each of a plurality of specific logic gates, such as an inverter (or inverter gate), an AND gate, a NAND gate, an OR gate, etc.

Each logic gate and/or logic function may be identified by a specific macro name. For example, an inverter may be represented by a macro inv, a buffer may be represented by a macro buf, a two-inputted AND gate may be represented by a macro and2, etc. Other macros may be provided for other logic gates, such as nand2, nor2, aoi and oaixor. Each created macro may have a corresponding library cell name, netlist ports, and/or schematic ports.

The various macros may be written using an editor and may be appended or provided to the macro library of the spreadsheet. For example, a 2 input NAND gate may have a function provided as follows:

Public Function Nan2 (ByVal a As Integer, ByVal b As
IntToBool a
IntToBool b
Nand2 = Not (a And b)
BoolToInt Nand2
End Function

Logic functions for other logic gates (or circuits) may also be provided and stored within the macro library corresponding to the spreadsheet.

Each macro (for a specific logic function) may be identified by a unique color code for easy recognition and understanding of the logic function corresponding to the macro. For example, the macro inv for an inverter may be represented by a light blue color, the macro nand2 for a 2-input NAND gate may be represented by a yellow color, and the macro nor2 may be represented by a green color. Other colors and/or gates may also be provided. Additionally, the data (or background of the data) displayed in the cells of the spreadsheet may also be similarly color coded. That is, the cells may be color coded based on functions representing gates.

Embodiments of the present invention may provide a library of logic gate functions and macros, a test macro, and a user extension as a plurality of modules (such as Visual Basic™ modules) to the spreadsheet. A computer executable program may also be provided for netlisting and schematic generation.

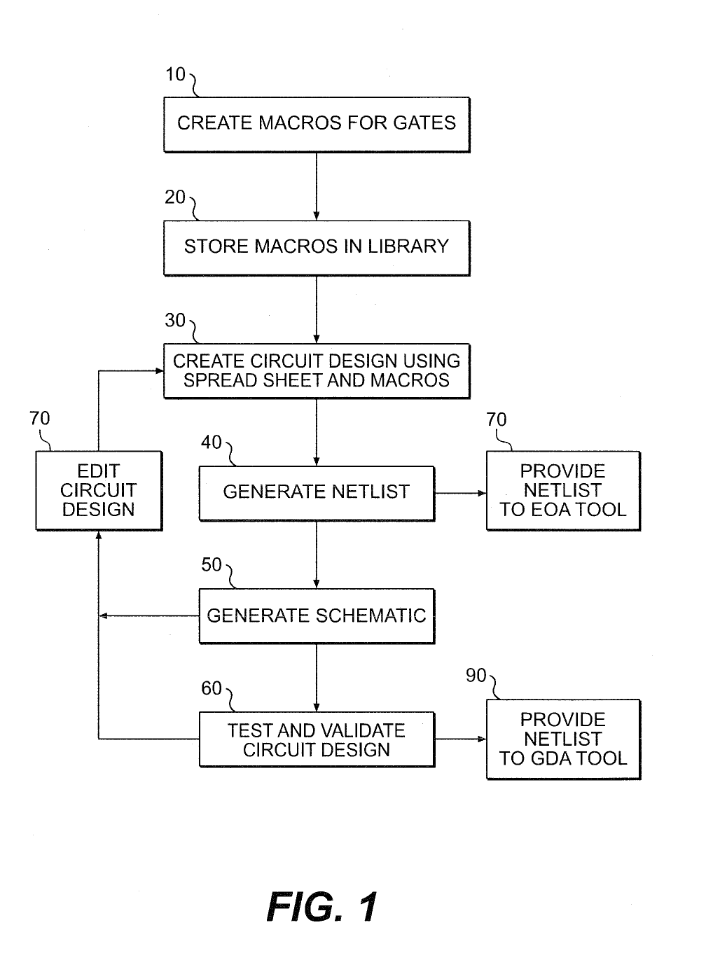

FIG. 1 is a flowchart of a method according to an example embodiment of the present invention. Other methods, operations and orders of operation are also within the scope of the present invention. More specifically, FIG. 1 shows that a plurality of macros (for gates) may be created in operation 10. Each of the macros may represent a logic gate or a logic function. The macros may be created for the spreadsheet or for other programs. The created macros may be stored in a module (or library) corresponding to the spreadsheet in operation 20. This may thereby create a library of created macros for use in circuit designing using the spreadsheet or other program.

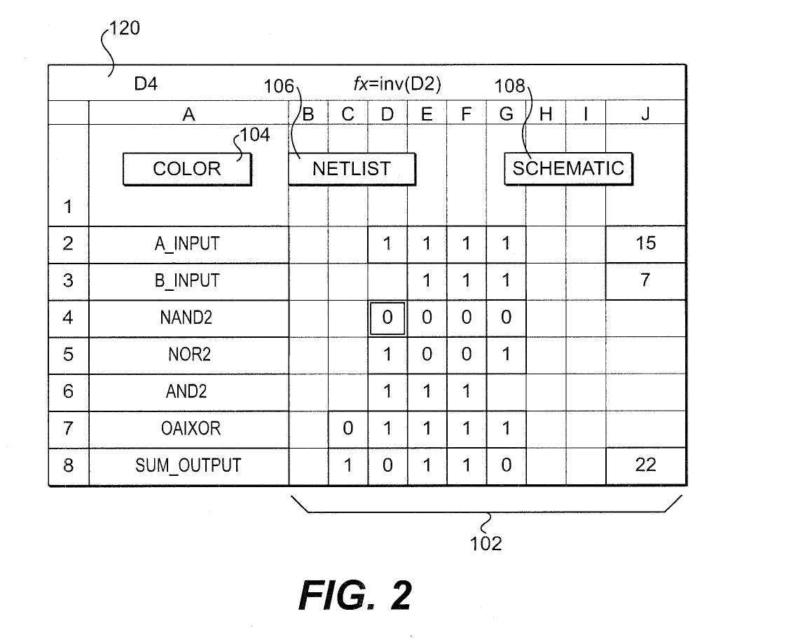

A circuit design may be input into the spreadsheet in operation 30. This may involve inputting of information corresponding to various circuit elements to represent the circuit using the spreadsheet. The circuit design may be implemented using the created macros that are stored in the library of macros. Stated differently, the operation 30 may include creating (and displaying) the circuit design using the spreadsheet and the created macros. FIG. 2, as will be described below, shows a portion of a circuit that is displayed using the spreadsheet. Once information related to the desired circuit is input (and/or stored) into the spreadsheet, various operations may then be performed using the data/information.

In operation 40, a netlist of the circuit described by the spreadsheet may be generated. The netlist may describe signals, components and interconnects of the circuit. The netlist may be generated or created in one or more of a plurality of different formats, such as Verilog. Once the netlist is generated in operation 40, a schematic of the circuit may be generated from the netlist in operation 50.

In operation 60, a user may further test and validate the described circuit by providing input values to various inputs of the circuit described by the spreadsheet. Stated differently, a user may test the circuit design by inputting values into the spreadsheet program. This may also be done to verify (or validate) the logic of the circuit.

In operation 70, the user may edit and/or display various portions of the circuit design described by the spreadsheet. The editing may also occur during and/or after other operations of FIG. 1.

Embodiments of the present invention may also allow the netlist to be provided to an electronic design automation (EDA) tool (or electronic design apparatus) in operation 80 or in operation 90. For example, this may be done after a successful testing and validation of the circuit design.

FIG. 2 shows a portion of a spreadsheet displaying a circuit design according to an example embodiment of the present invention. Other embodiments and configurations are also within the scope of the present invention. More specifically, FIG. 2 shows a portion of a two-dimensional matrix (of a spreadsheet program) that may be displayed on a screen as well as data to represent a specific circuit. FIG. 2 shows data/information corresponding to a 4 bit adder circuit. Other logic gates and/or data/information may also be provided.

The matrix may include a plurality of cells 102. Each of the cells 102 may be identified based on the name of the logic gate that is entered in each cell of the matrix. The cells 102 display the logic states (i.e., a “1” or a “0”) associated with the corresponding logic function.

The column A (on the left-hand side of the matrix) may list a plurality of names that may be used to describe the desired circuit represented in the matrix. For example, FIG. 2 shows that nand2, nor2, and2 and oaixor may be used to describe the logic of the 4 bit adder circuit. Input logic of the circuit may be represented by a “______input” suffix and output logic of the circuit may be represented by an “______output” suffix.

The column J (on the right-hand side of FIG. 2) may show decimal or hexadecimal values of various inputs and outputs. This column may be used for analyzing and/or debugging purposes. For example, for the 4 bit adder circuit represented in FIG. 2, column J shows the a_input having a decimal input value of 15 as determined based on cells within row 2 (corresponding to the a_input macro). Column J also shows the b_input having a decimal input value of 7 as determined based on cells within the row 3 (corresponding to the b_input macro). Still further, the column J also shows a total output (from the macro sum_output) having a decimal output value of 22 as determined based on cells within the row 8 (corresponding to the sum_output macro).

The cells in the column J may provide binary-to-hexadecimal or binary to decimal converted numbers for analyzing, debugging and/or testing purposes. This may be based on stored macros. For example, a macro “RangeToDec” may be provided to convert a binary number in a range of cells of a row (i.e., a plurality of cells of a row) into a decimal number. A macro “RangeToHex” may be provided to convert a binary number in a range of cells of a row (i.e., a plurality of cells of a row) into a hexadecimal number. A macro “RangeToBin” may be provided to convert a decimal or hexadecimal number into a binary number in a range of cells. Other macros may also be used.

As one example, the macro “RangeToDec(D2-G2)” may be associated with cell J2 so as to provide a function of converting a binary number represented by each of the cells D2-G2 into a decimal number and providing (or displaying) the result in cell J2. As shown in FIG. 2, the binary number 1111 represented by the cell range D2-G2 may be converted using the macro RangeToDec into a decimal value of 15 as shown in the cell J2. Similarly, other desired cells of the column J may also have associated macros to perform various functions.

The displayed screen for this example includes three executable buttons, namely, a Color button 104, a Netlist button 106, and a Schematic button 108. These executable buttons may be provided at a top of the matrix of the cells 102. The Color button 104 when executed may provide specific colors to information on the matrix based on the logic. The Netlist button 106 when executed may provide a netlist based on information within the matrix (i.e, the circuit described using the spreadsheet). Additionally, the Schematic button 108 when executed may provide or generate a circuit schematic based on information within the matrix.

In order to create a circuit design using the spreadsheet (as in operation 30) a user may enter (or input) specific information into the spreadsheet program (i.e., enter information into the matrix). For example, a user may input a cell number in area 120 and may enter information about the specific cell in area 130. The information entered into the area 130 may correspond to a logic formula corresponding to the specific cell.

As shown in FIG. 2, a user may identify cell D4 in the area 120 of the matrix. Cells corresponding to row 4 may relate to a nand2 macro. A user may enter a logic formula “=inv(D2)” at the area 120. This formula may be stored to correspond to the cell D4. Thus, the cell D4 may represent a logic NAND gate function by inverting an input from cell D2. The other cells may be defined for their logic functions by providing a formula corresponding to the specific cells using inputs and/or outputs of other cells.

Embodiments of the present invention may duplicate digital functional blocks at various positions of the spreadsheet by using ‘copy-paste’ feature.

The Netlist button 106 may be pressed or executed to create or generate a netlist based on information of the circuit design. A netlist may be created for the entire circuit design or for portions (or blocks) of the circuit design. A netlist for a selected block may be generated/created and stored in a file. The generated netlist can be ported to an electronic design automation (EDA) tool or apparatus for fabricating the circuit.

As discussed above, after generation of the netlist, the schematic may be generated by clicking or executing the Schematic button 108. The schematic may be displayed on the screen. The schematic may be saved as a postscript file.

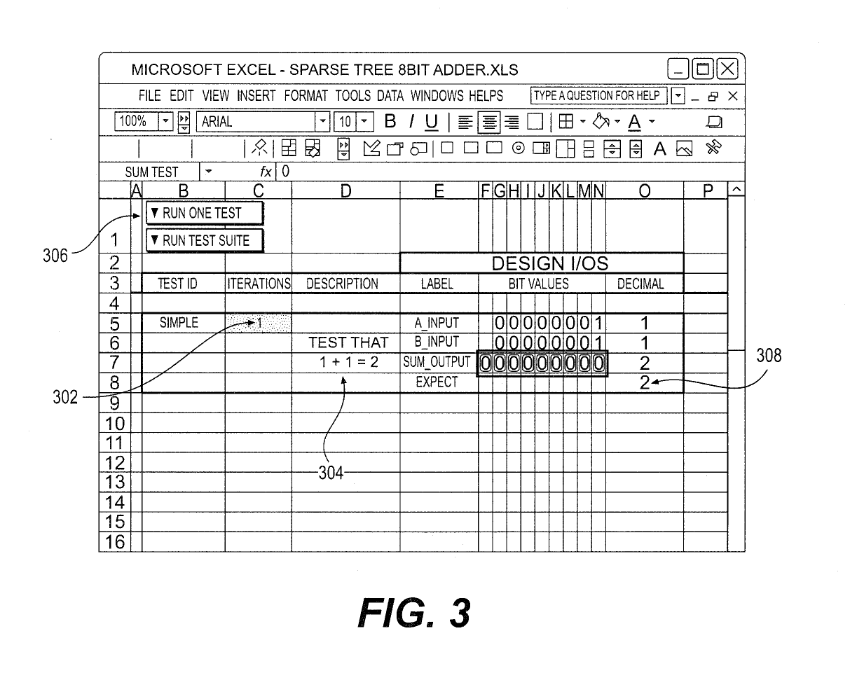

FIG. 3 shows a portion of a spreadsheet during testing of a circuit design according to an example embodiment of the present invention. Other embodiments, configurations and portions are also within the scope of the present invention. More specifically, FIG. 3 shows column headers such as Test ID, Iterations, Description, Label, Bit Value, and Decimal. Other columns may be provided as needed.

The circuit design testing may occur based on information in a grid within the defined columns. The grid may be filled with the required parameters. A Test id may be defined and assigned a name in a name box of a formula bar of the spreadsheet. The screen may also display a number of iterations at area 302. A description for the test may be provided in the Description column at area 304. For example, FIG. 3 shows the test description as “test that 1+1=2.” The Label column may identify the macros to be used for this circuit design, such as a_input, b_input, sum_output, and expect. The input bit values may be appropriately entered by the user. Additionally, the output cells contain the output data that may be used as a comparison of the actual output to the expected output.

A test button “Run One Test” 306 may be provided and assigned a macro “RunOneTest.” Another test button “Run Test Suite” may be provided and assigned a macro “RunTestSuite.” The test button “Run One Test” 306 may be clicked to run the test of the circuit design. An output of the bit values may be determined based on the output of the sum_output. The test result may be seen on area 308. If the test result in the area 308 matches with the expected result, then the cell in the area 302 (i.e., under the Iterations column) may become green to symbolize PASS. On the other hand, if the test result in the area 308 does not match with the expected result, then the cell in the area 302 may become red and the failing expected value is highlighted to symbolize FAIL.

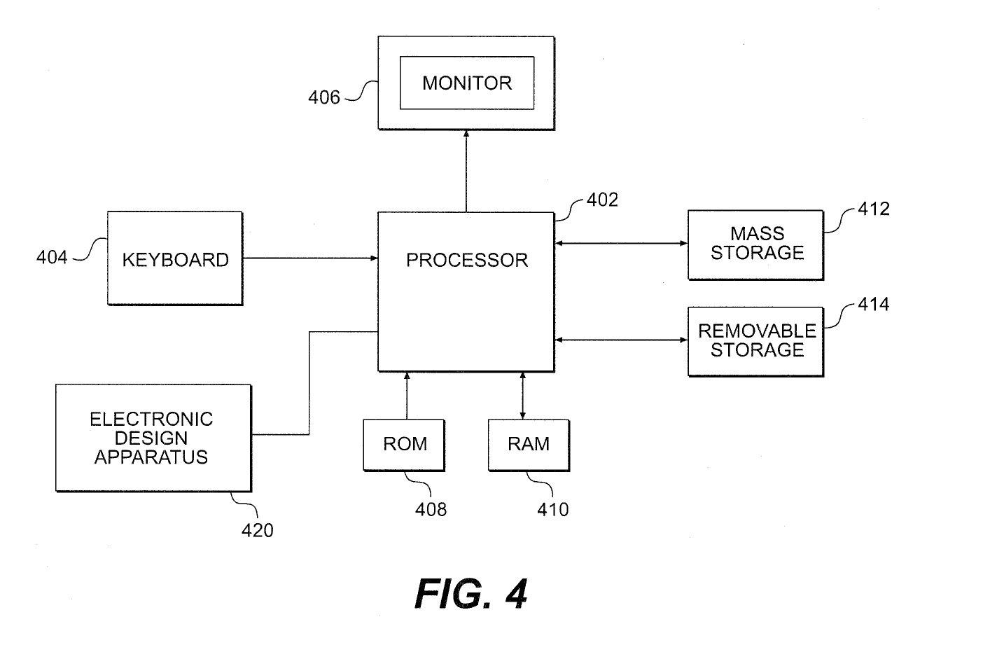

FIG. 4 is a block diagram of a computer system according to an example embodiment of the present invention. Other embodiments and configurations are also within the scope of the present invention. More specifically, FIG. 4 shows a processor 402, a keyboard 404, a monitor 406, read-only memory (ROM) 408, random-access memory (RAM) 410, mass storage 412, and removable storage 414. The system may also include an electronic design apparatus 420 to form the circuit design from a netlist.

A user may input data into the system using the keyboard 404. The mass storage 412 may be a hard disk storage unit capable of storing many megabytes of data in a non-volatile fashion. The removable storage 414 may be a floppy disk unit used to transfer data to and from the computer system.

The spreadsheet program may be stored in memory of the system. The spreadsheet may be displayed on the monitor 406. A user may create and store macros of logic gates in memory of the system. The user may also create the circuit design using the stored macros and the spreadsheet program. As discussed above, a netlist of a circuit design may be stored in memory of the computer system. The netlist may then be provided to the electronic design apparatus 420 to prepare the circuit design.

According, embodiments of the present invention may include a program code to be executed by the processor 402. The program code includes a spreadsheet program to create the circuit design and a plurality of macros (or macro code) each to represent one of a plurality of logic gates. The program code may further include a program (or code) to generate a netlist from a circuit design created using the spreadsheet and the plurality of macros. The code may also display the circuit design on the monitor 406 with each macros having a different color.

Embodiments of the present invention may provide a circuit design method that includes creating a plurality of macros each for one of a plurality of logic gates, storing the created macros, and creating a circuit design using a spreadsheet program, the circuit design being represented by the plurality of macros.

While embodiments of the present invention have been particularly shown and described with reference to specific embodiments thereof, it will be understood by those skilled in the art that changes in the form and details of the disclosed embodiments may be made. For example, the method described herein employ logic gate functions organized in spreadsheet. It will be understood, however, that the logic gate functions may be represented in a variety of ways without departing from the scope of the invention. For example, logic gate functions may be represented using any of a wide variety of commercially available database applications.

Moreover, specific embodiments have been described herein with reference to the determination of the parameters for a specific circuit model of the adder. It will be understood, however, that the method described herein may be applied to a wide variety of circuit models and that the use of a particular circuit model herein is merely exemplary.

Any reference in this specification to “one embodiment,” “an embodiment,” “example embodiment,” etc., means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A circuit design method comprising:
creating a plurality of macros each for one of a plurality of logic gates;
storing the created macros; and
creating a circuit design using a spreadsheet program, the circuit design being represented by the plurality of macros.

2. The circuit design method of claim 1, further comprising generating a netlist from the created circuit design.

3. The circuit design method of claim 2, further comprising displaying a schematic of the circuit design based on the generated netlist.

4. The circuit design method of claim 2, further comprising providing the generated netlist to an electronic design apparatus.

5. The circuit design method of claim 1, further comprising testing the circuit design by inputting values into the spreadsheet program.

6. The circuit design method of claim 1, further comprising displaying the circuit design on a screen of the spreadsheet program.

7. The circuit design method of claim 6, wherein the displaying includes displaying information associated with each macro in a different color.

8. A circuit design method comprising:
creating a circuit design on a screen of a spreadsheet program, the created circuit design including a plurality of macros; and
generating a netlist from the created circuit design.

9. The circuit design method of claim 8, further comprising displaying a schematic of the circuit design based on the generated netlist.

10. The circuit design method of claim 8, further comprising providing the generated netlist to an electronic design apparatus.

11. The circuit design method of claim 8, further comprising testing the circuit design by inputting values into the spreadsheet program.

12. The circuit design method of claim 8, further comprising displaying the circuit design on the screen of the spreadsheet program.

13. The circuit design method of claim 8, wherein the displaying includes displaying information associated with each of the plurality of macros in a different color.

14. The circuit design method of claim 8, further comprising creating the plurality of macros, each macro corresponding to one of a plurality of logic gates.

15. The circuit design method of claim 14, wherein the plurality of macros to represent logic functions of the plurality of logic gates.

16. A program code to be executed by a processor, the program code comprising:
a spreadsheet program to create a circuit design; and
a plurality of macros each to represent one of a plurality of logic gates.

17. The program code of claim 16, wherein the code further comprises a program to generate a netlist from a circuit design created using the spreadsheet and the plurality of macros.

18. The program code of claim 16, wherein the code displays the plurality of macros on a screen with each macro in a different color.
